(19) United States
(12) Patent Application Publication
(10) Pub. No.: US 2025/0205103 A1
(43) Pub. Date: Jun. 26, 2025

(54) WEARABLE DEVICE AND OPERATING METHOD THEREFOR

(71) Applicant: Samsung Electronics Co., Ltd., Suwon-si (KR)

(72) Inventors: Jungpil YU, Suwon-si (KR); Sukhoon SONG, Suwon-si (KR); Seokjae LEE, Suwon-si (KR); Kyunghun JANG, Suwon-si (KR)

(21) Appl. No.: 19/073,855

(22) Filed: Mar. 7, 2025

Related U.S. Application Data
(63) Continuation of application No. PCT/KR2023/012389, filed on Aug. 22, 2023.

(30) Foreign Application Priority Data
Sep. 13, 2022 (KR) 10-2022-0115073

(51) Int. Cl. A61H 3/00

(52) U.S. Cl. CPC A61H 3/00; A61H 2201/165; A61H 2201/5007; A61H 2201/5069

(57) ABSTRACT

A wearable device may include: a first sensor for measuring a joint angle of a user; a driving module, which generates torque through a motor so as to apply an external force to the user; and a processor, which receives angle information obtained by measuring the angle through the first sensor, determines, on the basis of the received angle information and a plurality of parameter values, first control information for generating the torque, controls the driving module on the basis of the determined first control information such that torque corresponding to the determined first control information is generated, determines reference values for changing parameters by using at least one from among angle values of the received angle information, a provided angular velocity value and a provided torque value, and changes at least one of the parameter values if at least one from among a first angle value received from the first sensor values after the reference values are determined, a first angular velocity value obtained after the reference values are determined, and a first torque value determined after the reference values are determined reaches one of the determined reference values.

### CROSS-REFERENCE TO RELATED APPLICATIONS

This application is a continuation application of International Application No. PCT/KR2023/012389 designating the United States, filed on Aug. 22, 2023, in the Korean Intellectual Property Receiving Office and claiming priority to Korean Patent Application No. 10-2022-0115073, filed on Sep. 13, 2022, the disclosures of which are all hereby incorporated by reference herein in their entireties.

### BACKGROUND

### Field

Certain example embodiments may relate to a wearable device and/or an operating method thereof.

### Background Art

In general, a walking assistance device refers to a mechanism or device that helps a patient, who cannot walk on his own due to various diseases, accidents, and the like, to perform walking exercises for rehabilitation treatment, and/or to a mechanism or device that may help a person exercise. With the recent intensifying aging societies, a growing number of people experience inconvenience in walking or have difficulty in normal walking due to malfunctioning joint issues, and there is increasing interest in walking assistance devices. A walking assistance device is to be worn on a body of a user to assist the user with walking, for example by providing a necessary muscular strength and/or to induce the user to walk in a normal walking pattern.

### SUMMARY

A wearable device according to an example embodiment may include a first sensor configured to measure an angle of a joint of a user, a driving module (comprising a motor and/or circuitry) configured to apply an external force to the user by generating a torque through the motor, and a processor, comprising processing circuitry, configured to receive angle information obtained by measuring the angle from the first sensor, determine first control information to generate the torque based on the received angle information and a plurality of parameter values, control the driving module based on the determined first control information to generate a torque corresponding to the determined first control information, determine reference values to change a parameter using at least one of angle values of the received angle information, a given angular velocity value, or a given torque value, and when at least one of a first angle value received from the first sensor after the reference values are determined, a first angular velocity value obtained after the reference values are determined, or a first torque value determined after the reference values are determined, reaches one of the determined reference values, change one or more parameter values.

A method of operating a wearable device according to an example embodiment may include obtaining angle information obtained by measuring an angle of a joint of a user through a first sensor, determining first control information to generate torque of a driving module based on the obtained angle information and a plurality of parameter values, controlling the driving module based on the determined first control information to generate a torque corresponding to the determined first control information, determining reference values to change a parameter using at least one of angle values of the obtained angle information, a given angular velocity value, or a given torque value, and when at least one of a first angle value obtained through the first sensor after the reference values are determined, a first angular velocity value obtained after the reference values are determined, or a first torque value determined after the reference values are determined, reaches one of the reference values, changing one or more parameter values.

### BRIEF DESCRIPTION OF DRAWINGS

FIG. 1 is a diagram illustrating an overview of a wearable device worn on a user's body, according to an example embodiment.

FIG. 2A is a front view of a wearable device according to an example embodiment.

FIG. 2B is a side view of a wearable device according to an example embodiment.

FIGS. 3A and 3B are block diagrams illustrating examples of a configuration of a wearable device according to an example embodiment(s).

FIG. 4 is a diagram illustrating an example of a torque output method of a wearable device according to an example embodiment.

FIGS. 5 and 6 are diagrams illustrating a wearable device according to an example embodiment(s).

FIGS. 7 to 11 are diagrams illustrating examples of parameter changes of a wearable device according to an example embodiment(s).

FIG. 12 is a flowchart illustrating a method of operating a wearable device, according to an example embodiment.

### DETAILED DESCRIPTION

The following detailed structural or functional description is provided as an example only and various alterations and modifications may be made to the embodiments. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if one component is described as being “connected”, “coupled”, or “joined” to another component, a third component(s) may be “connected”, “coupled”, and “joined” between the first and second components, although the first component may be directly connected, coupled, or joined to the second component. Thus, for example, “connected” as used herein covers both direct and indirect connections.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

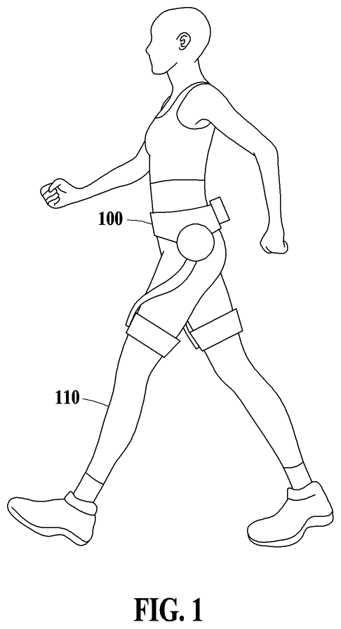

FIG. 1 is a diagram illustrating an overview of a wearable device worn on a user's body, according to an embodiment.

Referring to FIG. 1, a wearable device 100 may be a device worn on a body of a user 110 to assist the user 110 in walking, exercising, and/or working. In embodiments, the term “wearable device” may be replaced with “wearable robot,” or “walking assistance device”. The user may be a human or an animal, but is not limited thereto. The wearable device 100 may be worn on the body (e.g., a lower body (legs, ankles, knees, etc.) or a waist) of the user 110 and may provide an external force, such as an assistance force and/or a resistance force, to a body motion of the user 110. The assistance force may be a force applied in the same direction as the body motion direction of the user 110, and the resistance force may be a force applied in a direction opposite to the body motion direction of the user 110. The term “resistance force” may also be referred to as “exercise load”.

In an embodiment, when the wearable device 100 performs a walking assist function to assist the user 110 in walking, the wearable device 100 may assist a portion or entirety of a leg of the user 110 by providing an assistance force to the body of the user 110, thereby assisting the user 110 in walking. The wearable device 100 may enable the user 110 to walk independently or to walk for a long time by providing a force required for the user 110 to walk, thereby extending the walking ability of the user 110. The wearable device 100 may also improve the walking of a user having an abnormal walking habit or posture.

In an embodiment, when the wearable device 100 performs an exercise function to enhance the exercise effect of the user 110, the wearable device 100 may hinder a body motion of the user 110 or provide resistance to a body motion of the user 110 by providing a resistance force to the body of the user 110. When the wearable device 100 is, for example, a hip-type wearable device, the wearable device 100 may provide an exercise load to a body motion of the user 110 while being worn on the legs, thereby enhancing the exercise effect of the user 110. The user 110 may perform a walking motion while wearing the wearable device 100 for exercise. In this case, the wearable device 100 may apply a resistance force to the leg motion during the walking motion of the user 110.

In various embodiments of the present disclosure, an example of a hip-type wearable device 100 that is worn on the waist and legs is described for ease of description. However, as described above, the wearable device 100 may be worn on another body part (e.g., the upper arms, lower arms, hands, calves, and feet) other than the waist and legs (particularly, the thighs), and the shape and configuration of the wearable device may vary depending on the body part on which the wearable device 100 is worn.

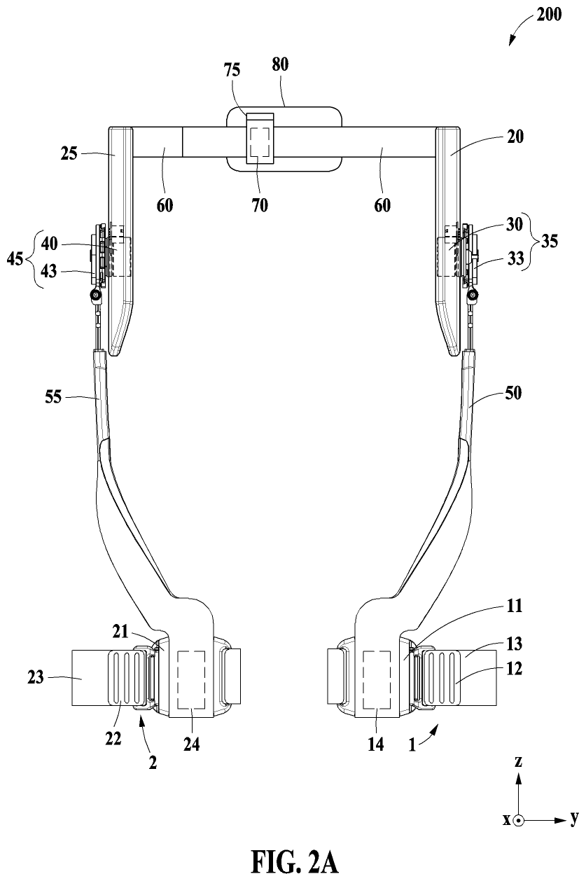

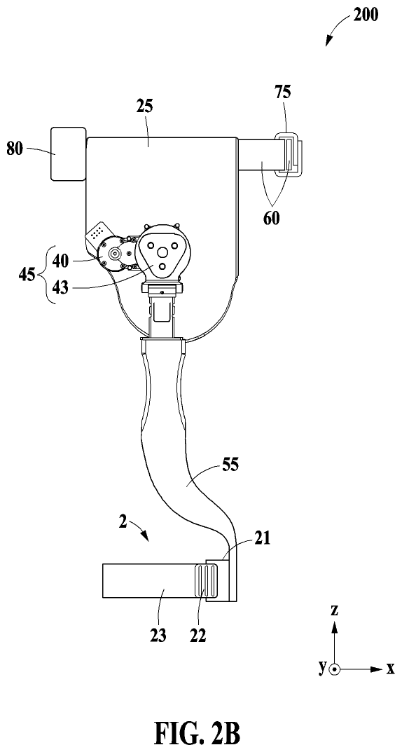

FIG. 2A is a front view of a wearable device according to an embodiment and FIG. 2B is a side view of a wearable device according to an embodiment.

Referring to FIGS. 2A and 2B, a wearable device 200 (e.g., the wearable device 100 of FIG. 1) according to an embodiment may include a control module 80, waist support frames 20 and 25, driving modules 35 and 45, thigh support frames 50 and 55, thigh fasteners 1 and 2, thigh fastening detection modules 14 and 24, a waist fastener, and a waist fastening detection module 70. In an embodiment, at least one (e.g., the waist fastening detection module 70 or an auxiliary belt 75) of the components may be omitted from the wearable device 100, or one or more other components may be added to the wearable device 100.

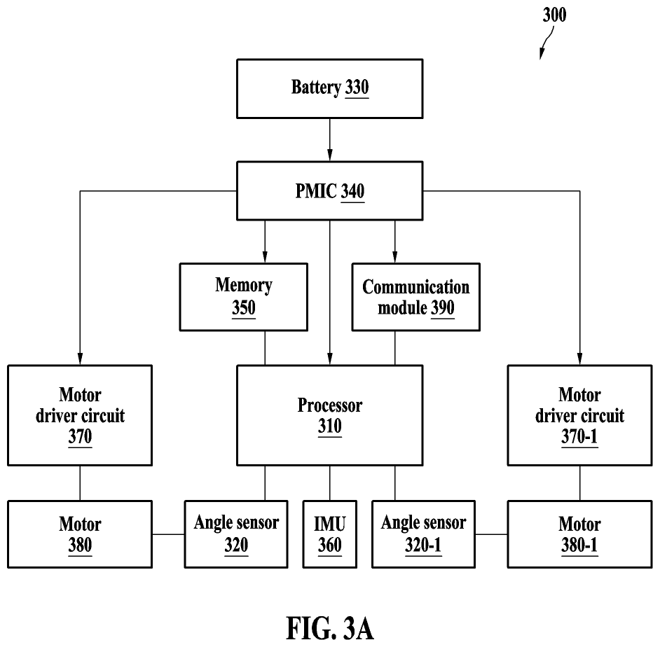

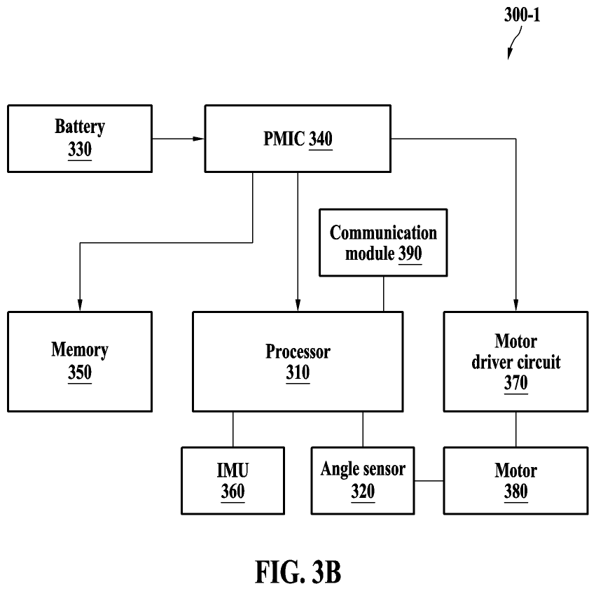

In an embodiment, the control module 80 may generate a control signal to control the wearable device 100 and may control an operation of the wearable device 100 through the control signal. The control module 80 may include a processor (e.g., a processor 310 of FIGS. 3A and 3B) to control actuators 30 and 40, an inertial measurement unit (IMU) 360, a memory (e.g., a memory 350 of FIGS. 3A and 3B), and a communication module (e.g., a communication module 390 of FIGS. 3A and 3B). Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

For example, the control module 80 may be disposed on the back or a rear side of the waist of a user based on a state in which the wearable device 100 is worn on the body of the user. “Based on” as used herein covers based at least on.

In an embodiment, the waist support frames 20 and 25 may support a body part (e.g., the waist) of the user when the wearable device 100 is worn on the body of the user. The waist support frames 20 and 25 may contact at least a portion of an outer surface of the user. The waist support frames 20 and 25 may be bent in a shape corresponding to a portion in contact with the body of the user. For example, the waist support frames 20 and 25 may have a shape surrounding the outer surface of the waist (or pelvis) of the user and may support the waist of the user. The waist support frames 20 and 25 may include the first waist support frame 25 configured to support a right side of the waist of the user, and the second waist support frame 20 configured to support a left side of the waist of the user. The waist support frames 20 and 25 may be connected, directly or indirectly, to the control module 80.

The waist fastener may be connected, directly or indirectly, to the waist support frames 20 and 25 and may fasten the waist support frames 20 and 25 to the waist of the user. The waist fastener may include, for example, a pair of belts 60 and the auxiliary belt 75. The auxiliary belt 75 may be connected, directly or indirectly, to one of the pair of belts 60.

In an embodiment, the pair of belts 60 may be connected, directly or indirectly, to the waist support frames 20 and 25. In a state before the user wears the wearable device 100, the pair of belts 60 may maintain a shape extending in a front direction (e.g., the +x direction) and may not hinder the user from entering inside the pair of waist support frames 20. When the user enters inside the pair of waist support frames 20 and 25, the pair of belts 60 may be deformed and may surround a front portion of the user as shown in the drawings. The waist support frames 20 and 25 and the pair of belts 60 may entirely surround the circumference of the waist of the user. In an embodiment, the auxiliary belt 75 may fasten the pair of belts 60 to each other while the pair of belts 60 overlaps with each other. For example, one of the pair of belts 60 may wrap the other belt together with the auxiliary belt 75.

The waist fastening detection module 70 may detect whether the waist fastener is fastened to the waist of the user. For example, the waist fastening detection module 70 may include a sensor (not shown) (e.g., a proximity sensor and/or an inertial sensor) configured to obtain sensor data in which a value varies depending on whether the pair of belts 60 and the auxiliary belt 75 are firmly connected to each other and may transmit the obtained sensor data to the control module 80.

The driving modules 35 and 45 may generate an external force to be applied to the body of the user based on a control signal generated by the control module 80. The driving modules 35 and 45 may include the first driving module 45 disposed at a position corresponding to a right hip joint of the user and the second driving module 35 disposed at a position corresponding to a left hip joint of the user. The first driving module 45 may include a first actuator 40 and a first joint member 43, and the second driving module 35 may include a second actuator 30 and a second joint member 33. The first actuator 40 may provide power to be transmitted to the first joint member 43 and the second actuator 30 may provide power to be transmitted to the second joint member 33. The first actuator 40 and the second actuator 30 may each include a motor configured to generate power by receiving power from a battery (e.g., a battery 330 of FIGS. 3A and 3B). When the motor is driven as the power is supplied to the motor, the motor may provide an assistance force for assisting a body motion of the user or a resistance force for hindering a body motion of the user.

In an embodiment, the first joint member 43 and the second joint member 33 may receive power from the first actuator 40 and the second actuator 30, respectively, and may apply an external force to the body of the user based on the received power. The first joint member 43 and the second joint member 33 may be disposed at positions corresponding to joint portions of the user, respectively. The first joint member 43 and the second joint member 33 may be disposed on one side of the waist support frames 20 and 25, respectively. One side of the first joint member 43 may be connected, directly or indirectly, to the first actuator 40, and the other side of the first joint member 43 may be connected, directly or indirectly, to the first thigh support frame 55. The first joint member 43 may rotate by the power received from the first actuator 40. A first encoder for measuring a rotation angle of the first joint member 43 may be disposed on one side of the first joint member 43. One side of the second joint member 33 may be connected to the second actuator 30, and the other side of the second joint member 33 may be connected to the second thigh support frame 50. The second joint member 333 may rotate by the power received from the second actuator 30. A second encoder for measuring a rotation angle of the second joint member 33 may also be disposed on one side of the second joint member 33.

In an embodiment, the first actuator 40 may be disposed in a lateral direction of the first joint member 43, and the second actuator 30 may be disposed in a lateral direction of the second joint member 33. A rotation axis of the first actuator 40 and a rotation axis of the first joint member 43 may be spaced apart from each other, and a rotation axis of the second actuator 30 and a rotation axis of the second joint member 33 may also be spaced apart from each other. However, embodiments are not limited thereto, and the actuators 30 and 40 and the joint members 33 and 43 may share a rotation axis. In an embodiment, the actuators 30 and 40 may be spaced apart from the joint members 33 and 43, respectively. In this case, the driving modules 35 and 45 may further include a power transmission module (not shown) configured to transmit power from the actuators 30 and 40 to the joint members 33 and 43. The power transmission module may be a rotary body, such as a gear, or a longitudinal member, such as a wire, a cable, a string, a spring, a belt, or a chain. However, the scope of embodiments is not limited by the positional relationship between the actuator 30 or 40 and the joint member 33 or 43 and the power transmission structure described above.

In an embodiment, the thigh support frames 50 and 55 may support thighs of the user when the wearable device 100 is worn on the body of the user. The thigh support frame 50 or 55 may transmit power generated by the driving module 35 or 45 to the thigh of the user, and the power may act as an external force to be applied to a body motion of the user. One end of the thigh support frame 50 or 55 may be connected to the joint member 33 or 43 and may rotate, and as the other end of the thigh support frame 50 or 55 is connected to a cover 11 or 21 of the thigh fastener 1 or 2, the thigh support frame 50 or 55 may transmit the power generated by the driving module 35 or 45 to the thigh of the user while supporting the thigh of the user. For example, the thigh support frame 50 or 55 may push or pull the user's thigh. The thigh support frame 50 or 55 may extend in a longitudinal direction of the user's thigh. The thigh support frame 50 or 55 may be bent to surround at least a portion of the circumference of the user's thigh. For example, an upper portion of the thigh support frame 50 or 55 may cover a portion oriented in a lateral direction (e.g., the +y direction or the −y direction) of the user's body, and a lower portion of the thigh support frame 50 or 55 may cover a portion oriented in a front direction (e.g., the +x direction) of the user's body. The thigh support frames 50 and 55 may include the first thigh support frame 55 configured to support the right thigh of the user and the second thigh support frame 50 configured to support the left thigh of the user.

The thigh fastener 1 or 2 may be connected, directly or indirectly, to the leg support frame 50 or 55 and may fasten the thigh support frame 50 or 55 to the thigh. The thigh fasteners 1 and 2 may include the first thigh fastener 2 configured to fasten the first thigh support frame 55 to the right thigh of the user and the second thigh fastener 1 configured to fasten the second thigh support frame 50 to the left thigh of the user. The first thigh fastener 2 may include a first cover 21, a first fastening frame 22, and a first strap 23, and the second thigh fastener 1 may include a second cover 11, a second fastening frame 12, and a second strap 13.

In an embodiment, the cover 11 or 21 may apply an external force generated by the driving module 35 or 45 to the user's thigh. For example, the cover 11 or 21 may be disposed on one side of the user's thigh and may push or pull the user's thigh. For example, the cover 11 or 21 may be disposed on a front surface of the user's thigh. The cover 11 or 21 may be disposed in a circumferential direction of the user's thigh. The cover 11 or 21 may extend to both sides from the other end of the thigh support frame 50 or 55 and may include a curved surface corresponding to the thigh of the user. One end of the cover 11 or 21 may be connected, directly or indirectly, to the fastening frame 12 or 22 and the other end of the cover 11 or 21 may be connected, directly or indirectly, to the strap 13 or 23.

In an embodiment, one end of the fastening frame 12 or 22 may be connected, directly or indirectly, to one side of the cover 11 or 21 and the other end may be connected, directly or indirectly, to the strap 13 or 23. For example, the fastening frame 12 or 22 may be disposed to surround at least a portion of the circumference of the user's thigh and may prevent or reduce a chance of the user's thigh from being separated from the thigh support frame 50 and/or 55. The first fastening frame 22 may have a fastening structure that connects the first cover 21 to the first strap 23 and the second fastening frame 12 may have a fastening structure that connects the second cover 11 to the second strap 13.

The strap 13 or 23 may surround a remaining portion that is not covered by the cover 11 or 21 and the fastening frame 12 or 22 in the circumference of the user's thigh and may include an elastic material (e.g., a band).

The thigh fastening detection module 14 or 24 may detect whether the thigh fastener 1 or 2 is fastened to the thigh of the user. The thigh fastening detection module 14 or 24 may obtain sensor data in which a value varies depending on whether the thigh fastener 1 or 2 is fastened to the thigh of the user and may transmit the obtained sensor data to the control module 80. The thigh fastening detection module 14 or 24 may include the first thigh fastening detection module 24 configured to detect whether the first thigh fastener 2 is fastened to the right thigh of the user and the second thigh fastening detection module 14 configured to detect whether the second thigh fastener 1 is fastened to the left thigh of the user.

In an embodiment, the wearable device 100 may support a proximal part and a distal part of the user and may assist a relative motion between the proximal part and the distal part. Among the components of the wearable device 100, components worn on the proximal part of the user may be referred to as a “proximal wearing unit” and components worn on the distal part of the user may be referred to as a “distal wearing unit”. For example, among the components of the wearable device 100, the control module 80, the waist support frames 20 and 25, the pair of belts 60, and the auxiliary belt 70 may correspond to a proximal wearing unit, and the thigh fasteners 1 and 2 may correspond to a distal wearing unit. For example, the proximal wearing unit may be worn on a waist or a pelvis of the user, and the distal wearing unit may be worn on a thigh or a calf of the user. Positions in which the proximal wearing unit and the distal wearing unit are worn are not limited thereto. For example, the proximal wearing unit may be worn on a torso or a shoulder of the user, and the distal wearing unit may be worn on an upper arm or a lower arm of the user.

FIGS. 3A and 3B are block diagrams illustrating examples of a configuration of a wearable device according to an embodiment.

According to an embodiment, a wearable device 300 (e.g., the wearable device 100 of FIG. 1 and the wearable device 200 of FIG. 2) may include a processor 310, angle sensors 320 and 320-1, a battery 330, a power management integrated circuit (PMIC) 340, a memory 350, an IMU 360, motor driver circuits 370 and 370-1, motors 380 and 380-1, and a communication module 390 comprising communication circuitry.

Although the plurality of angle sensors 320 and 320-1, the plurality of motor driver circuits 370 and 370-1, and the plurality of motors 380 and 380-1 are shown in FIG. 3, which is merely an example, the wearable device 300-1 in the example shown in FIG. 3B may include a single angle sensor 320, a single motor driver circuit 370, and a single motor 380. Also, according to the implementation, the wearable devices 300 and 300-1 may include a plurality of processors. The number of motor driver circuits, the number of motors, or the number of processors may vary depending on a body part on which the wearable devices 300 and 300-1 are worn.

The angle sensor 320, the motor driver circuit 370, and the motor 380 may be included in the first driving module 45 of FIG. 2, and the angle sensor 320-1, the motor driver circuit 370-1, and the motor 380-1 may be included in the second driving module 35. Each “driving module” or “drive module” herein may comprise a motor and/or drive circuitry (e.g., see FIGS. 3a-3b).

The angle sensor 320 may measure or sense an angle of a first joint (e.g., a right hip joint) of a user. The angle sensor 320 may transmit angle information measuring the angle of the first joint to the processor 310. For example, the angle sensor 320 may measure a right hip joint angle of the user and may transmit angle information on the measured the right hip joint angle to the processor 310.

The angle sensor 320-1 may measure an angle of a second joint (e.g., a left hip joint) of the user and may transmit angle information on the measured angle of the second joint to the processor 310.

According to an embodiment, the angle sensors 320 and 320-1 may additionally measure knee angles and ankle angles of the user depending on the positions of the angle sensors 320 and 320-1.

The angle sensors 320 and 320-1 may be the first encoder and the second encoder, respectively, described with reference to FIG. 2.

According to an embodiment, the wearable devices 300 and 300-1 may include a potentiometer. The potentiometer may sense an R-axis joint angle, an L-axis joint angle, an R-axis joint angular velocity, and an L-axis joint angular velocity according to a walking motion of the user. In this example, the R and L axes may be reference axes for the right leg and the left leg of the user, respectively. For example, the R/L axis may be set to be vertical to the ground and set such that a front side of a body of a person has a negative value and a rear side of the body has a positive value.

The PMIC 340 may charge the battery 330 using power supplied from an external power source. For example, the external power source and the wearable devices 300 and 300-1 may be connected, directly or indirectly, through a cable (e.g., a universal serial bus (USB) cable, etc.). The PMIC 340 may receive power from the external power source through the cable, and charge the battery 330 using the received power. According to embodiments, the PMIC 340 may charge the battery 330 through a wireless charging method.

The PMIC 340 may transmit the power stored in the battery 330 to a component in the wearable device 300 or 300-1. For example, the PMIC 340 may adjust the power stored in the battery 330 to a voltage or a current level suitable for a component (e.g., the processor 310, the angle sensors 320 and 320-1, the memory 350, the IMU 360, and the motors 380 and 380-1) in the wearable device 300. The PMIC 340 may include, for example, a converter (e.g., a direct current (DC)-DC converter) or a regulator (e.g., a low-dropout (LDO) regulator or a switching regulator) configured to perform the adjustment described above.

The PMIC 340 may determine state information (e.g., a state of charge, a state of health, an overvoltage, a low voltage, an overcurrent, an overcharge, an overdischarge, an overheating, a short circuit, or a swelling) of the battery 330, and transmit the state information of the battery 330 to the processor 310. The processor 310 may provide the state information of the battery 330 to the user through an output module described below.

The IMU 360 may obtain or measure acceleration information (or posture information) of the user. For example, the IMU 360 may measure or obtain 3-axis (e.g., X-axis, Y-axis, and Z-axis) accelerations and rotation angles (e.g., roll, pitch, and yaw) according to a walking motion of the user. The IMU 330 may transmit the obtained acceleration information (e.g., the measured 3-axis accelerations and rotation angles) to the processor 310.

The processor 310 may control the wearable devices 300 and 300-1 overall.

The processor 310 may, for example, control the components (e.g., the motor driver circuits 370 and 370-1, etc.) in the wearable devices 300 and 300-1 by executing software (e.g., a program or instructions) stored in the memory 350, and perform various data processing or computation. As at least a portion of the data processing or computation, the processor 310 may store data received from other components (e.g., the IMU 360, the angle sensors 320 and 320-1, etc.) in the memory 350, and process the instructions or data stored in the memory 350.

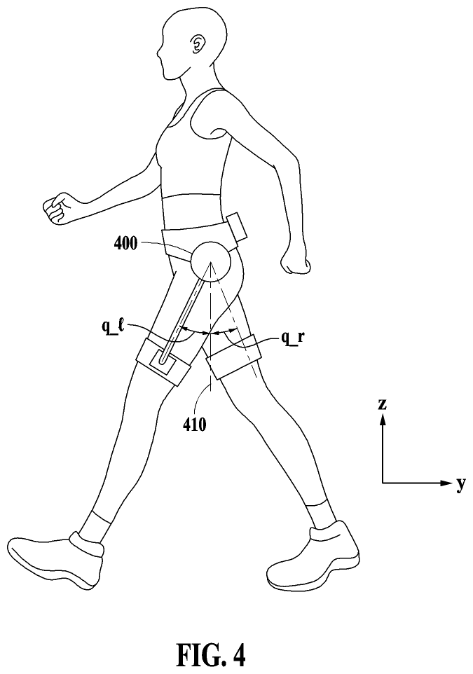

Although described with reference to FIG. 4, the processor 310 may determine control information for generating a torque of each of the motors 380 and 380-1 and may control the motor driver circuits 370 and 370-1 based on the determined control information.

The motor driver circuits 370 and 370-1 may control the motors 380 and 380-1 based on the control information received from the processor 310 and the motors 380 and 380-1 may generate torques by this control, respectively.

The communication module 390 may support establishing a direct (e.g., wired) communication channel or wireless communication channel between the wearable devices 300 and 300-1 and an external electronic device and performing communication through the established communication channel. The communication module may include one or more communication processors configured to support direct (or wired) communication or wireless communication. According to an embodiment, the communication module may include a wireless communication module (e.g., a cellular communication module, a short-range wireless communication module, or a global navigation satellite system (GNSS) communication module) or a wired communication module (e.g., a local area network (LAN) communication module or a power line communication (PLC) module). A corresponding one of these communication modules may communicate with the external electronic device via a first network (e.g., a short-range communication network such as Bluetooth™, wireless-fidelity (Wi-Fi) direct, or infrared data association (IrDA)) or a second network (e.g., a legacy cellular network, a 5G network, a next-generation communication network, the Internet, or a computer network). These various types of communication modules may be implemented as a single component (e.g., a single chip), or may be implemented as multi components (e.g., multi chips) separate from each other.

Although not shown in FIGS. 3A and 3B, the wearable device 300 and 300-1 may include an output module configured to provide information to a user or provide feedback (e.g., visual feedback, auditory feedback, and haptic feedback) to a user. The output module may include, for example, at least one of a sound output module (e.g., a speaker, etc.) configured to output sound, a vibration output module (e.g., a vibration motor, etc.) configured to output vibration (or haptic feedback), or a display module (e.g., a display, a light-emitting diode (LED), etc.) configured to notify a user of a state (e.g., a charging state, a communication connection state between an external electronic device and the wearable devices 300 and 300-1) of the wearable devices 300 and 300-1 or a combination thereof.

FIG. 4 is a diagram illustrating a torque output method of a wearable device according to an embodiment.

In the example illustrated in FIG. 4, a wearable device 400 (e.g., the wearable device 100 of FIG. 1, the wearable device 200 of FIG. 2, the wearable device 300 of FIG. 3A, and the wearable device 300-1 of FIG. 3B) may be a hip-type wearable device worn on a hip joint part.

The wearable device 400 may obtain first raw angle information q_r_raw(t) obtained by measuring a right hip joint angle q_r and second raw angle information q_l_raw(t) obtained by measuring a left hip joint angle q_l. For example, a first angle sensor (e.g., the angle sensor 320 of FIG. 3A) may obtain the first raw angle information q_r_raw (t) obtained by measuring the right hip joint angle q_r and may transmit the first raw angle information to the processor 310 and a second angle sensor (e.g., the angle sensor 320-1 of FIG. 3A) may obtain the second raw angle information q_l_raw(t) obtained by measuring the left hip joint angle q_l and may transmit the second raw angle information to the processor 310. As illustrated in FIG. 4, the left hip joint angle q_l may be a negative number because the left leg is before a reference line 410, and the right hip joint angle q_r may be a positive number because the right leg is behind the reference line 410. Depending on the implementation, the right hip joint angle q_r may be a negative number when the right leg is before the reference line 410, and the left hip joint angle q_l may be a positive number when the left leg is behind the reference line 410.

The wearable device 400 (e.g., the processor 310) may determine control information τ(t) to generate a torque based on the first raw angle information q_r_raw(t), the second raw angle information q_l_raw(t), and a plurality of parameters (e.g., sensitivity α, a gain κ, and a delay Δt).

In an embodiment, the wearable device 400 (e.g., the processor 310) may obtain filtered first raw angle information q_r(t) and filtered second raw angle information q_l(t) by filtering the first raw angle information q_r_raw(t) and the second raw angle information q_l_raw(t) through a first filter (e.g., a low-pass filter). For example, the first filter may be expressed by Equation 1 below. The first filter is not limited to Equation 1 below.

$$\overline{x} ( t ) = ( 1 - α ) \overline{x} ( t - 1 ) + α x ( t ) , 0 < α < 1 \qquad [ Equation 1 ]$$

In the above Equation 1, x(t) at a time point t may denote an input (e.g., q_r_raw(t) and q_l_raw(t)), x̅(t−1) may denote a filtering result (e.g., q_r(t−1) and q_l(t−1)) of the first filter at a previous time point t−1, and x̅(t) may denote a filtering result (e.g., q_r(t) and q_l(t)) of the first filter at the time point t. α in Equation 1 may be a coefficient of the first filter and may correspond to the sensitivity described above. According to Equation 1, the filtered first raw angle information q_r(t) may be, for example, expressed by (1−α)×q_r(t−1)+α×q_r_raw(t) and the filtered second raw angle information q_l(t) may be, for example, expressed by (1−α)×q_l(t−1)+α×q_l_raw(t).

A high frequency element may be removed from the first raw angle information q_r_raw(t) and the second raw angle information q_l_raw(t) by filtering by the first filter.

The wearable device 400 (e.g., the processor 310) may determine the control information τ(t) based on Equation 2 below.

$$y ( t ) = sin ( q\_r ( t ) ) - sin ( q\_l ( t ) ) \qquad [ Equation 2 ]$$

$$τ ( t ) = κ y ( t - Δ t )$$

In Equation 2, y(t) may be a state factor indicating a state of a movement of the user. For example, the state factor y(t) may be related to the distance between the two legs. y(t) being “0” may indicate a state in which the distance between the legs is “0” (e.g., a crossing state), and the absolute value of y(t) being maximum may indicate a state (e.g., a landing state) in which the angle between the legs is maximum.

A gain κ may be a parameter indicating the magnitude and direction of an output a torque.

As the value of the gain κ increases, a greater torque may be output. If the gain κ is negative, a torque acting as a resistance force may be output to the user, and if the gain κ is positive, a torque acting as an assistance force may be output to the user.

A delay Δt may be a parameter associated with a torque output timing. The value of the gain κ and the value of the delay Δt may be preset and may be adjustable by the user, the wearable device 400, or an electronic device (e.g., a smartphone or a tablet personal computer (PC)) paired with the wearable device 400.

The embodiment in which the processor 310 filters the first raw angle information q_r_raw(t) and the second raw angle information q_l_raw(t) through the first filter is described above but the embodiment is an example. In an embodiment, the processor 310 may determine a state factor y_{raw}(t) corresponding to a difference between q_r_raw(t) and q_l_raw(t) and may filter the determined y_{raw}(t) through the first filter. For example, the processor 310 may determine y_{raw}(t)=sin(q_r_raw(t))−sin(q_l_raw(t)) and may perform filtering on y_{raw}(t) through the first filter of Equation 1 shown above. The filtering result y_{fil}(t) may be, for example, (1−α)×y_{fil}(t−1)+α×y_{raw}(t). The processor 310 may determine the control information τ(t) by applying the gain and delay to the filtering result y_{fil}(t).

According to an embodiment, the wearable device 400 (e.g., the processor 310) may determine control information τᵣ(t) to generate a torque by the motor 380 corresponding to the right hip joint and control information τₗ(t) to generate a torque by the motor 380-1 corresponding to the left hip joint, through Equation 3 below.

$${τ}_{r} ( t ) = τ ( t ) \qquad [ Equation 3 ]$$

$${τ}_{l} ( t ) = - τ ( t )$$

τᵣ(t) and τₗ(t) may have the same magnitude and opposite torque directions.

The wearable device 400 (e.g., the processor 310) may control the motor driver 370 to output the torque corresponding to τᵣ(t) by the motor 380 and may control the motor driver 370-1 to output the torque corresponding to τₗ(t) by the motor 380-1.

According to an embodiment, when the user performs an asymmetrical gait with the left leg and the right leg, the wearable device 300 may provide asymmetrical torques respectively to both legs of the user to assist the asymmetric gait. For example, a stronger assistance force may be provided to a leg with a shorter stride width or a slower swing speed. Hereinafter, a leg with a small stride width or a slow swing speed will be referred to as an affected leg or a target leg.

In general, an affected leg may have a shorter swing time or a smaller stride width than an unaffected leg. According to an embodiment, a method of adjusting the timing of a torque acting on an affected leg to assist a gait of a user may be considered. For example, a parameter (e.g., an offset angle c) may be added to an actual joint angle of an affected leg to increase an output time of a torque for assisting a swing motion of the affected leg. For example, q_r(t) and q_l(t) may be adjusted through Equation 4 below.

$$q\_r ( t ) ← q\_r ( t ) + {c}_{r} \qquad [ Equation 4 ]$$

$$q\_l ( t ) ← q\_l ( t ) + {c}_{l}$$

In Equation 4, cᵣ may denote an offset angle for the right hip joint and cₗ may denote an offset angle for the left hip joint.

The wearable device 400 (e.g., the processor 310) may determine a state factor y_{c}(t) to which an offset angle c is applied through Equation 5 below and may determine control information τ_{c}(t) to which the offset angle c is applied.

$${y}_{c} ( t ) = sin ( q\_r ( t ) + {c}_{r} ) - sin ( q\_l ( t ) + {c}_{l} ) \qquad [ Equation 5 ]$$

$${τ}_{c} ( t ) = κ {y}_{c} ( t - Δ t )$$

The wearable device 400 (e.g., the processor 310) may determine control information τ_{c_r}(t) to generate a torque by the motor 380 corresponding to the right hip joint and control information τ_{c_l}(t) to generate a torque by the motor 380-1 corresponding to the left hip joint, through Equation 6 below.

$${τ}_{c \_ r} ( t ) = {τ}_{c} ( t ) \qquad [ Equation 6 ]$$

$${τ}_{c \_ l} ( t ) = - {τ}_{c} ( t )$$

The wearable device 400 (e.g., the processor 310) may control the motor driver 370 to output the torque corresponding to τ_{c_r}(t) by the motor 380 and may control the motor driver 370-1 to output the torque corresponding to τ_{c_l}(t) by the motor 380-1.

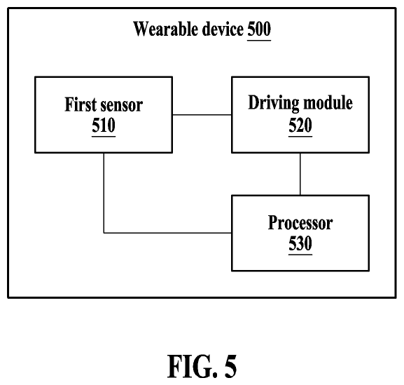

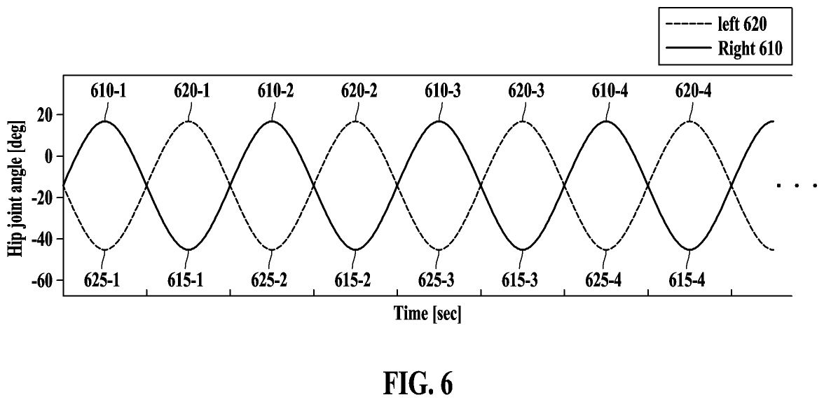

FIGS. 5 and 6 are diagrams illustrating a wearable device according to an embodiment.

Referring to FIG. 5, a wearable device 500 (e.g., the wearable device 100 of FIG. 1, the wearable device 200 of FIG. 2, the wearable device 300 of FIG. 3A, the wearable device 300-1 of FIG. 3B, and the wearable device 400 of FIG. 4) may include a first sensor 510, a driving module 520 (e.g., the driving modules 35 and 45 of FIG. 2), and a processor 530 (e.g., the processor 310). The first sensor 510 may include the angle sensors 320 and 320-1 of FIG. 3A. Alternatively, the first sensor 510 may include the angle sensor 320 of FIG. 3B.

The first sensor 510 may measure an angle of a joint (e.g., a hip joint) of a user. For example, the first sensor 510 may measure each angle of both hip joints and may transmit angle information obtained by measuring both hip joint angles (e.g., q_r_raw(t) and q_l_raw(t) described with reference to FIG. 4) to the processor 530.

The driving module 520 may apply an external force (e.g., a resistance force and an auxiliary force) to the user by generating a torque through a motor (e.g., the motors 380 and 380-1 of FIG. 3A).

The processor 530 may determine first control information τ₁(t) to generate a torque based on the angle information (e.g., q_r_raw(t) and q_l_raw(t) described with reference to FIG. 4) and parameter values through Equation 2 above. The parameter values may include at least one of the gain, delay, sensitivity, or the offset angle described with reference to FIG. 4 or a combination of the gain, delay, sensitivity, or the offset angle.

The processor 530 may control the driving module 520 based on the first control information determined to generate the torque corresponding to the determined first control information.

The processor 530 may determine one or more reference values to change a parameter using at least one of angle values of the received angle information, a given angular velocity value (e.g., 0 rad/s), or a given torque value (e.g., 0 Nm). When at least one of a first angle value received from the first sensor 510 after the one or more reference values are determined, a first angular velocity value of a joint angle obtained after the one or more reference values are determined, or a first torque value determined after the one or more reference values are determined, reaches the one or more reference values, the processor 530 may change one or more parameter values.

In an embodiment, the processor 530 may detect peak values from angle values of the received angle information, may determine an angle value in which a rotation direction of the joint changes using the detected peak values, and may determine the one or more reference values to change the parameters using the determined angle value.

FIG. 6 illustrates an example of angle information 610 (e.g., q_r_raw(t)) of a right hip joint angle and angle information 620 (e.g., q_l_raw(t)) of a left hip joint angle.

The processor 530 may detect positive peak values 610-1, 610-2, 610-3, 610-4, etc., and negative peak values 615-1, 615-2, 615-3, 615-4, etc., from angle values of the angle information 610 of the right hip joint angle.

The processor 530 may calculate an average value (hereinafter, referred to as a “first average angle value”) of the positive peak values 610-1, 610-2, 610-3, 610-4, etc. The processor 530 may calculate the first average angle value to be, for example, 18°. When the angle of the right hip joint reaches the first average angle value (e.g., 18°) from the reference line 410, the processor 530 may determine that the rotation direction of the right hip joint changes from a first direction to a second direction. In this case, the first direction may be a direction in which the joint swings backward and the second direction may be a direction in which the joint swings forward. The processor 530 may determine a value (e.g., 13°) obtained by subtracting a predetermined value x₁ (e.g., 5°) from the first average angle value (e.g., 18°) to be a first reference value r₁ that serves as a criterion for changing a parameter value of the first control information.

The processor 530 may calculate an average value (hereinafter, referred to as a “second average angle value”) of the negative peak values 615-1, 615-2, 615-3, 615-4, etc. The processor 530 may calculate the second average angle value to be, for example, −48°. When the angle of the right hip joint reaches the second average angle value (e.g., −48°) from the reference line 410, the processor 530 may determine that the rotation direction of the right hip joint changes from the second direction to the first direction. The processor 530 may determine a value (e.g., −43°) obtained by adding the predetermined value x₁ (e.g., 5°) to the second average angle value (e.g., −48°) to be a second reference value r₂ that serves as a criterion for changing a parameter value of the first control information.

The processor 530 may detect positive peak values 620-1, 620-2, 620-3, 620-4, etc., and negative peak values 625-1, 625-2, 625-3, 625-4, etc., from angle values of the angle information 620 of the left hip joint angle.

The processor 530 may calculate an average value (hereinafter, referred to as a “third average angle value”) of the positive peak values 620-1, 620-2, 620-3, 620-4, etc. The processor 530 may calculate the third average angle value to be, for example, 19°. When the angle of the left hip joint reaches the third average angle value (e.g., 19°) from the reference line 410, the processor 530 may determine that the rotation direction of the left hip joint changes from the first direction to the second direction. The processor 530 may determine a value (e.g., 14°) obtained by subtracting the predetermined value x₁ (e.g., 5°) from the third average angle value (e.g., 19°) to be a third reference value r₃ that serves as a criterion for changing a parameter value of the first control information.

The processor 530 may calculate an average value (hereinafter, referred to as a “fourth average angle value”) of the negative peak values 625-1, 625-2, 625-3, 625-4, etc. The processor 530 may calculate the fourth average angle value to be, for example, −47°. When the angle of the left hip joint reaches the fourth average angle value (e.g., −47°) from the reference line 410, the processor 530 may determine that the rotation direction of the left hip joint changes from the second direction to the first direction. The processor 530 may determine a value (e.g., −42°) obtained by adding the predetermined value x₁ (e.g., 5°) to the fourth average angle value (e.g., −47°) to be a fourth reference value r₄ that serves as a criterion for changing a parameter value of the first control information.

In an embodiment, the processor 530 may detect a maximum value and a minimum value from the angle values of the received angle information, may determine the detected maximum value and the detected minimum value to be angle values in which the rotation direction of the joint changes, and may determine one or more reference values to change parameters using the determined angle values.

For example, the processor 530 may detect a maximum value (e.g., 20°) and a minimum value (e.g., −50°) from the angle values of the angle information 610 of the right hip joint angle.

The processor 530 may determine a value (e.g., 15°) obtained by subtracting the predetermined value x₁ (e.g., 5°) from the detected maximum value (e.g., 20°) to be the first reference value r₁. The processor 530 may determine a value (e.g., −45°) obtained by adding the predetermined value x₁ (e.g., 5°) to the detected minimum value (e.g., −50°) to be the second reference value r₂.

The processor 530 may detect a maximum value (e.g., 19°) and a minimum value (e.g., −48°) from the angle values of the angle information 620 of the left hip joint angle.

The processor 530 may determine a value (e.g., 14°) obtained by subtracting the predetermined value x₁ (e.g., 5°) from the detected maximum value (e.g., 19°) to be the first reference value r₃. The processor 530 may determine a value (e.g., −43°) obtained by adding the predetermined value x₁ (e.g., 5°) to the detected minimum value (e.g., −48°) to be the second reference value r₄.

As described below, when the measured angle value of the right hip joint angle reaches the first reference value and/or the second reference value after the first to fourth reference values r₁, r₂, r₃, and r₄ are determined, the processor 530 may change one or more parameter values of the first control information. When the measured angle value of the left hip joint angle reaches the third reference value and/or the fourth reference value after the first to fourth reference values r₁, r₂, r₃, and r₄ are determined, the processor 530 may change one or more parameter values of the first control information.

In an embodiment, the processor 530 may determine one or more reference values to change parameters using a given angular velocity value (e.g., 0 rad/s). For example, the processor 530 may determine a value obtained by adding a predetermined value ω₁ to a given angular velocity value (e.g., 0) to be a fifth reference value r₅ and may determine a value obtained by subtracting a predetermined value ω₂ from the given angular velocity value (e.g., 0) to be a sixth reference value r₆. The predetermined values ω₁ and ω₂ may be the same or different. Each of the predetermined values ω₁ and ω₂ may be, for example, 0.05 rad/s, but the example is not limited thereto.

As described below, when the angular velocity value of the right hip joint angle reaches the fifth reference value and/or the sixth reference value after the fifth and sixth reference values r₅ and r₆ are determined, the processor 530 may change one or more parameter values of the first control information.

In an embodiment, the processor 530 may determine one or more reference values to change parameters using a given torque value (e.g., 0 Nm). For example, the processor 530 may determine a value obtained by adding a predetermined value τₓ to a given torque value (e.g., 0) to be a seventh reference value r₇ and may determine a value obtained by subtracting a predetermined value τ_{y} from the given angular velocity value (e.g., 0) to be an eighth reference value r₈. The predetermined values τₓ and τ_{y} may be the same or different. Each of the predetermined values τₓ and τ_{y} may be, for example, 0.5 Nm, but the example is not limited thereto.

As described below, when the torque value of the first control information reaches the seventh reference value and/or the eighth reference value after the seventh and eighth reference values r₇ and r₈ are determined, the processor 530 may change one or more parameter values of the first control information.

Hereinafter, changing a parameter is described.

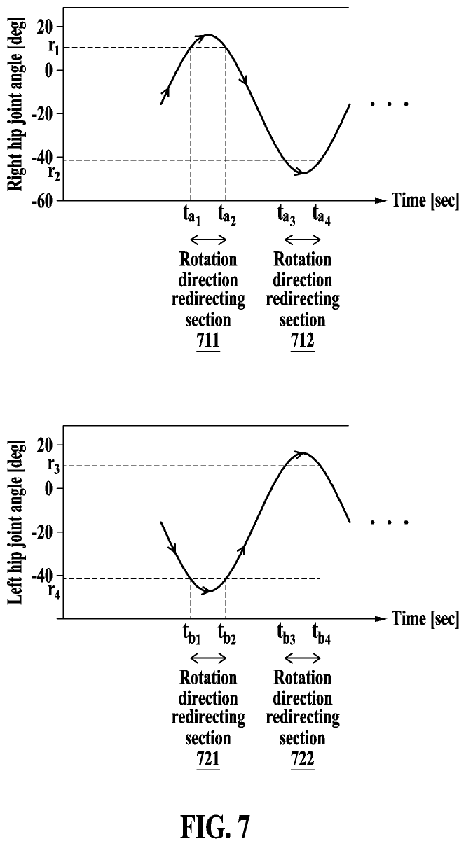

FIGS. 7 to 11 are diagrams illustrating examples of parameter changes of a wearable device according to an embodiment.

Referring to FIG. 7, rotation direction redirecting sections 711, 712, 721, and 722 are illustrated.

A hip joint of a user may have a range of motion. Due to this, motors (e.g., the motors 380 and 380-1 of FIG. 3A) of the wearable device 500 may be redirected (or changed) around an upper bound and a lower bound of the range of motion. When the rotation direction of the motors is redirected, stress may be applied to a mechanical part (e.g., the driving module 520, etc.) of the wearable device 500 due to the redirection of the rotation direction of the motors, and the wearable device 500 may not operate smoothly. Due to this, noise may occur in the wearable device 500, wear on the mechanical part of the wearable device 500 may be accelerated, the lifespan of the wearable device 500 may be shortened, and the wearability felt by the user may be degraded.

To ensure smooth operation of the wearable device 500 and minimize the stress applied to the mechanical part when redirecting the rotation direction of the motors, the wearable device 500 may output a torque based on the control information in which one or more parameter values are changed in the rotation direction redirecting sections 711, 712, 721, and 722. Depending on the implementation, the wearable device 500 may not output a torque by changing one or more parameter values in at least one of the rotation direction redirecting sections 711, 712, 721, and 722. Hereinafter, an example of changing a parameter of the wearable device 500 is described with reference to FIG. 7.

The processor 530 of the wearable device 500 may obtain first raw angle information obtained by measuring the right hip joint angle and second raw angle information obtained by measuring the left hip joint angle using the first sensor 510 after the reference values r₁, r₂, r₃, r₄ are determined.

In the example of FIG. 7, the processor 530 may determine the first control information τ₁(t) based on the first raw angle information, the second raw angle information, and the parameter values (e.g., a delay value, a gain value, and a sensitivity value) through Equation 2 above. The delay value of the first control information may be a first delay value (e.g., 0.25), the gain value may be a first gain value (e.g., 6), and the sensitivity value may be a first sensitivity value (e.g., 0.1). The processor 530 may control the driving module 520 based on the first control information to generate the torque corresponding to the first control information.

At a time point t_{b1}, the angle value of the left hip joint angle may reach the fourth reference value r₄. The processor 530 may change one or more parameter values of the first control information at the time point t_{b1} at which the angle value of the left hip joint angle reaches the fourth reference value r₄.

In an embodiment, when the angle value of the left hip joint angle reaches the fourth reference value r₄, the processor 530 may change the delay value among the parameter values of the first control information to a second delay value (e.g., 0.1) from the first delay value (e.g., 0.25). The processor 530 may determine second control information τ₂(t) based on the second delay value (e.g., 0.1), the first gain value, the first sensitivity value, the first raw angle information, and the second raw angle information and may control the driving module 520 based on the second control information to output a torque corresponding to the second control information. Depending on the implementation, the processor 530 may further change at least one of the gain value or the sensitivity value in addition to changing the delay value from the first delay value to the second delay value.

In an embodiment, when the angle value of the left hip joint angle reaches the fourth reference value r₄, the processor 530 may change the gain value among the parameter values of the first control information to a second gain value (e.g., 0) from the first gain value (e.g., 6). When the second gain value is 0, τ(t)=0 may be satisfied according to Equation 2 above. When the second gain value is 0, the driving module 520 may not output the torque. Depending on the implementation, the second gain value may be a value that is less than the first gain value and greater than 0 (e.g., 1). The processor 530 may determine third control information τ₃(t) based on the first delay value, the second gain value, the first sensitivity value, the first raw angle information, and the second raw angle information and may control the driving module 520 based on the third control information to output a torque corresponding to the third control information. In this case, the driving module 520 may output a torque having an intensity less than the torque corresponding to the first control information. The processor 530 may further change at least one of the delay value or the sensitivity value in addition to changing the gain value from the first gain value to the second gain value.

In an embodiment, when the angle value of the left hip joint angle reaches the fourth reference value r₄, the processor 530 may change the sensitivity value among the parameter values of the first control information from the first sensitivity value (e.g., 0.1) to a second sensitivity value (e.g., 0). As described above, the sensitivity may denote a coefficient of the first filter. The second sensitivity value of 0 may denote that the coefficient of the first filter is 0. When the sensitivity value is between 0 and 1, the first filter may output, for example, (1−α)×q_r(t−1)+α×q_r_raw(t) and (1−α)×q_l(t−1)+α×q_l_raw(t). When the sensitivity value is 0, the first filter may output, for example, (1−α)×q_r(t−1) and (1−α)×q_l(t−1). When the sensitivity value is 0, even if the first filter receives both hip joint angles at the time point t as an input, the first filter may filter and may not output the both hip joint angles and may output filtering results (1−α)×q_r(t−1) and (1−α)×q_l(t−1) at a time point t−1 previous to the time point t. When the sensitivity value is 0, even if the first filter receives both hip joint angles at later time points (e.g., t+1, t+2, etc.) as an input, the first filter may filter and may not output the both hip joint angles and may output filtering results (1−α)×q_r(t−1) and (1−α)×q_l(t−1) at the time point t−1.

The processor 530 may determine the control information by applying the first delay value and the first gain value to a state factor. The control information determined after the sensitivity value is changed to 0 may be the same as the control information determined before the sensitivity value is changed to 0. Accordingly, when the sensitivity value is changes to 0, the driving module 520 may output the torque before the sensitivity value is changed to 0. For example, when the sensitivity value is changed to 0 while driving module 520 outputs a torque of 1 Nm, the driving module 520 may output the torque of 1 Nm.

Depending on the embodiment, the second sensitivity value may be greater than 0 and less than the first sensitivity value. The processor 530 may further change at least one of the gain value or the delay value in addition to changing the sensitivity value from the first sensitivity value to the second sensitivity value.

At a time point tₐ₁ after the time point t_{b1}, the angle value of the right hip joint angle may reach the first reference value r₁. Since the parameter has already been changed, the processor 530 may not change the parameter even when the angle value of the right hip joint angle reaches the first reference value r₁.

At a time point t_{b2} after the time point tₐ₁, the angle value of the left hip joint angle may reach the fourth reference value r₄. The rotation direction redirecting section 721 of the left hip joint (or the second driving module 35 corresponding to the left hip joint) may be terminated. However, the right hip joint (or the first driving module 45 corresponding to the right hip joint) may still be in the rotation direction redirecting section 711. Since the right hip joint (or the first driving module 45) is in the rotation direction redirecting section 711 even though the rotation direction redirecting section 721 of the left hip joint (or the second driving module 35) is terminated, the processor 530 may maintain the parameter value (e.g., the second delay value, the second gain value, or the second sensitivity value) that is changed to smoothly perform redirection of the rotation direction.

At a time point tₐ₂ after the time point t_{b2}, the angle value of the right hip joint angle may reach the first reference value r₁. At the time point tₐ₂, the rotation direction redirecting section 721 of the left hip joint (or the second driving module 35) or the rotation direction redirecting section 711 of the right hip joint (or the first driving module 45) may be terminated. In this case, the processor 530 may revert the changed parameter value (e.g., the second delay value, the second gain value, or the second sensitivity value) to the parameter value before the change. For example, the processor 530 may change the delay value from the second delay value to the first delay value. For example, the processor 530 may change the gain value from the second gain value to the first gain value. For example, the processor 530 may change the sensitivity value from the second sensitivity value to the first sensitivity value.

The processor 530 may determine the first control information based on the first raw angle information, the second raw angle information, and the parameter values (e.g., the first delay value, the first gain value, and the first sensitivity value) and may control the driving module 520 to generate the torque corresponding to the first control information based on the first control information.

At a time point tₐ₃, the angle value of the right hip joint angle may reach the second reference value r₂. Because the rotation direction redirecting sections of both hip joints do not begin and then the rotation direction redirecting section 712 of the right hip joint may begin first after the time point tₐ₂, the processor 530 may change one or more parameter values of the first control information. For example, the processor 530 may perform at least one of changing the delay value from the first delay value to the second delay value, changing the gain value from the first gain value to the second gain value, and changing the sensitivity value from the first sensitivity value to the second sensitivity value among the parameter values of the control information.

At a time point t_{b3} after the time point tₐ₃, the angle value of the left hip joint angle may reach the third reference value r₃. Since the processor 530 changes the parameter when the angle value of the right hip joint angle reaches the second reference value r₂, the processor 530 may not change the parameter when the angle value of the left hip joint angle reaches the third reference value r₃.

At a time point tₐ₄ after the time point t_{b3}, the angle value of the right hip joint angle may reach the second reference value r₂. The rotation direction redirecting section 712 of the right hip joint may be terminated. However, the left hip joint may still be in the rotation direction redirecting section 722. In this case, the processor 530 may maintain the changed parameter value (e.g., the second delay value, the second gain value, or the second sensitivity value) to smoothly perform redirection of the rotation direction.

At a time point t_{b4} after the time point tₐ₄, the angle value of the left hip joint angle may reach the third reference value r₃. At the time point t_{b4}, the rotation direction redirecting section 721 of the left hip joint (or the second driving module 35) or the rotation direction redirecting section 711 of the right hip joint (or the first driving module 45) may be terminated. In this case, the processor 530 may revert the changed parameter value (e.g., the second delay value, the second gain value, or the second sensitivity value) to the parameter value before the change. For example, the processor 530 may change the delay value from the second delay value to the first delay value. For example, the processor 530 may change the gain value from the second gain value to the first gain value. For example, the processor 530 may change the sensitivity value from the second sensitivity value to the first sensitivity value.

The processor 530 may determine the first control information based on the first raw angle information, the second raw angle information, and the parameter values (e.g., the first delay value, the first gain value, and the first sensitivity value) and may control the driving module 520 to generate the torque corresponding to the first control information based on the first control information.

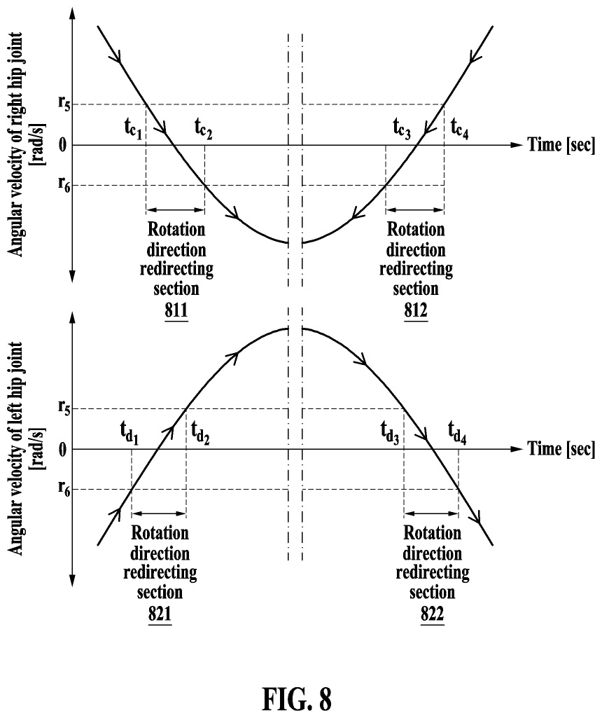

Referring to FIG. 8, rotation direction redirecting sections 811, 812, 821, and 822 are illustrated.

As described with reference to FIG. 7, to ensure smooth operation of the wearable device 500 and minimize the stress applied to the mechanical part when redirecting the rotation direction of the motors (e.g., the motors 380 and 380-1 of FIG. 3A), the wearable device 500 may output a torque based on the control information in which one or more parameter values are changed in at least one of the rotation direction redirecting sections 811, 812, 821, and 822. Depending on the implementation, the wearable device 500 may not output a torque by changing one or more parameter values in the rotation direction redirecting sections 811, 812, 821, and 822. Hereinafter, an example of changing a parameter of the wearable device 500 is described with reference to FIG. 8.

The processor 530 of the wearable device 500 may obtain angular velocity information of the right hip joint angle using the first raw angle information obtained by measuring the right hip joint angle. The processor 530 may obtain angular velocity information of the left hip joint angle using the second raw angle information obtained by measuring the left hip joint angle. For example, the processor 530 may obtain the angular velocity information of the right hip joint angle by differentiating the first raw angle information and may obtain the angular velocity information of the left hip joint angle by differentiating the second raw angle information. This is an example the processor 530 may receive the angular velocity information of the right hip joint angle and the angular velocity information of the left hip joint angle from a sensor configured to measure the angular velocity.

In the example of FIG. 8, the processor 530 may determine the first control information τ₁(t) based on the first raw angle information, the second raw angle information, and the parameter values (e.g., a delay value, a gain value, and a sensitivity value) through Equation 2 above. The delay value of the first control information may be a first delay value (e.g., 0.25), the gain value may be a first gain value (e.g., 6), and the sensitivity value may be a first sensitivity value (e.g., 0.1). The processor 530 may control the driving module 520 based on the first control information to generate the torque corresponding to the first control information.

At a time point t_{d1}, the angular velocity value of the left hip joint angle may reach the sixth reference value r₆. The processor 530 may change one or more parameter values of the first control information at the time point t_{d1} at which the angular velocity value of the left hip joint angle reaches the sixth reference value r₆.

In an embodiment, the processor 530 may change the delay value among the parameter values of the first control information to a second delay value (e.g., 0.1) from the first delay value (e.g., 0.25). The processor 530 may determine second control information τ₂(t) based on the second delay value (e.g., 0.1), the first gain value, the first sensitivity value, the first raw angle information, and the second raw angle information and may control the driving module 520 based on the second control information to output a torque corresponding to the second control information. The processor 530 may further change at least one of the gain value or the sensitivity value in addition to changing the delay value from the first delay value to the second delay value.

In an embodiment, the processor 530 may change the gain value among the parameter values of the first control information to a second gain value (e.g., 0) from the first gain value (e.g., 6). When the second gain value is 0, τ(t)=0 may be satisfied according to Equation 2 above. When the second gain value is 0, the driving module 520 may not output the torque. Depending on the implementation, the second gain value may be a value that is less than the first gain value and greater than 0 (e.g., 1). The processor 530 may determine third control information τ₃(t) based on the first delay value, the second gain value, the first sensitivity value, the first raw angle information, and the second raw angle information and may control the driving module 520 based on the third control information to output a torque corresponding to the third control information. In this case, the driving module 520 may output a torque having an intensity less than the torque corresponding to the first control information. The processor 530 may further change at least one of the delay value or the sensitivity value in addition to changing the gain value from the first gain value to the second gain value.

In an embodiment, the processor 530 may change the sensitivity value among the parameter values of the first control information to the second sensitivity value (e.g., 0) from the first sensitivity value (e.g., 0.1). The second sensitivity value of 0 may denote that the coefficient of the first filter is 0. When the coefficient of the first filter is 0, the driving module 520 may output a torque at a predetermined intensity (e.g., a torque according to a torque value determined before the coefficient of the first filter is changed to 0). Depending on the implementation, the second sensitivity value may be greater than 0 and less than the first sensitivity value. The processor 530 may further change at least one of the gain value or the delay value in addition to changing the sensitivity value from the first sensitivity value to the second sensitivity value.

At a time point t_{c1} after the time point t_{d1}, the angular velocity value of the right hip joint angle may reach the fifth reference value r₅. Since the parameter has already been changed, the processor 530 may not change the parameter even when the angular velocity value of the right hip joint angle reaches the fifth reference value r₅.

At a time point t_{d2} after the time point t_{c1}, the angular velocity value of the left hip joint angle may reach the fifth reference value r₅. The rotation direction redirecting section 821 of the left hip joint (or the second driving module 35 corresponding to the left hip joint) may be terminated. However, the right hip joint (or the first driving module 45 corresponding to the right hip joint) may still be in the rotation direction redirecting section 811. Since the right hip joint (or the first driving module 45) is in the rotation direction redirecting section 811 even though the rotation direction redirecting section 821 of the left hip joint (or the second driving module 35) is terminated, the processor 530 may maintain the parameter value (e.g., the second delay value, the second gain value, or the second sensitivity value) that is changed to perform smooth redirection of the rotation direction.

At a time point t_{c2} after the time point t_{d2}, the angular velocity value of the right hip joint angle may reach the sixth reference value r₆. At the time point t_{c2}, the rotation direction redirecting section 821 of the left hip joint (or the second driving module 35) or the rotation direction redirecting section 811 of the right hip joint (or the first driving module 45) may be terminated. In this case, the processor 530 may revert the changed parameter value (e.g., the second delay value, the second gain value, or the second sensitivity value) to the parameter value before the change. For example, the processor 530 may change the delay value from the second delay value to the first delay value. For example, the processor 530 may change the gain value from the second gain value to the first gain value. For example, the processor 530 may change the sensitivity value from the second sensitivity value to the first sensitivity value.

The processor 530 may determine the first control information based on the first raw angle information, the second raw angle information, and the parameter values (e.g., the first delay value, the first gain value, and the first sensitivity value) and may control the driving module 520 to generate the torque corresponding to the first control information based on the first control information.

At a time point t_{c3}, the angular velocity value of the right hip joint angle may reach the sixth reference value r₆. Because the rotation direction redirecting sections of both hip joints do not begin and then the rotation direction redirecting section 812 of the right hip joint may begin first after the time point t_{c2}, the processor 530 may change one or more parameter values of the first control information. For example, the processor 530 may perform at least one of changing the delay value from the first delay value to the second delay value, changing the gain value from the first gain value to the second gain value, and changing the sensitivity value from the first sensitivity value to the second sensitivity value among the parameter values of the control information.

At a time point t_{d3} after the time point t_{c3}, the angular velocity value of the left hip joint angle may reach the fifth reference value r₅. Since the processor 530 changes the parameter when the angular velocity value of the right hip joint angle reaches the sixth reference value r₆, the processor 530 may not change the parameter when the angular velocity value of the left hip joint angle reaches the fifth reference value r₅.

At a time point t_{c4} after the time point t_{d3}, the angular velocity value of the right hip joint angle may reach the fifth reference value r₅. The rotation direction redirecting section 812 of the right hip joint may be terminated. However, the left hip joint may still be in the rotation direction redirecting section 722. In this case, the processor 530 may maintain the changed parameter value (e.g., the second delay value, the second gain value, or the second sensitivity value) to perform smooth redirection of the rotation direction.

At a time point t_{d4} after the time point t_{c4}, the angular velocity value of the left hip joint angle may reach the sixth reference value r₆. At the time point t_{d4}, the rotation direction redirecting section 821 of the left hip joint (or the second driving module 35) or the rotation direction redirecting section 811 of the right hip joint (or the first driving module 45) may be terminated. In this case, the processor 530 may revert the changed parameter value (e.g., the second delay value, the second gain value, or the second sensitivity value) to the parameter value before the change. For example, the processor 530 may change the delay value from the second delay value to the first delay value. For example, the processor 530 may change the gain value from the second gain value to the first gain value. For example, the processor 530 may change the sensitivity value from the second sensitivity value to the first sensitivity value.

The processor 530 may determine the first control information based on the first raw angle information, the second raw angle information, and the parameter values (e.g., the first delay value, the first gain value, and the first sensitivity value) and may control the driving module 520 to generate the torque corresponding to the first control information based on the first control information.

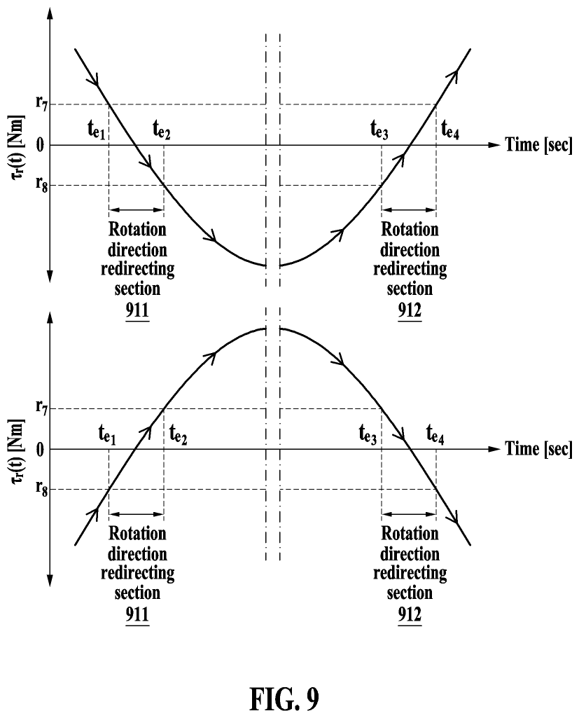

Referring to FIG. 9, rotation direction redirecting sections 911 and 912 are illustrated.

As described above, to ensure smooth operation of the wearable device 500 and minimize the stress applied to the mechanical part when redirecting the rotation direction of the motors (e.g., the motors 380 and 380-1 of FIG. 3A), the wearable device 500 may output a torque based on the control information in which one or more parameter values are changed in the rotation direction redirecting sections 911 and 912. Depending on the implementation, the wearable device 500 may not output a torque by changing one or more parameter values in the rotation direction redirecting sections 911 and 912. Hereinafter, an example of changing a parameter of the wearable device 500 is described with reference to FIG. 9.

In the example of FIG. 9, τᵣ(t) and τₗ(t) may have the same value but different signs. Due to this, the rotation direction redirecting section of τᵣ(t) and the rotation direction redirecting section of τₗ(t) may be the same.

In the example of FIG. 9, the processor 530 may control the first control information τ_{r_1}(t) to generate a torque by a motor (e.g., the motor 380 of FIG. 3A) corresponding to the right hip joint and the first control information τ_{l_1}(t) to generate a torque by a motor (e.g., the motor 380-1 of FIG. 3A) corresponding to the left hip joint, based on the first raw angle information, the second raw angle information, and the parameter values (e.g., the delay value, the gain value, and the sensitivity value) through Equation 2 and Equation 3 above. The delay value of the first control information τ_{r_1}(t) and τ_{l_1}(t) may be a first delay value (e.g., 0.25), the gain value may be a first gain value (e.g., 6), and the sensitivity value may be a first sensitivity value (e.g., 0.1).

At a time point tₑ₁, a torque value of τ_{r_1}(t) may reach the seventh reference value r₇ and a torque value of τ_{l_1}(t) may reach the eighth reference value r₈. In this case, the processor 530 may change at least one of the parameter values of the first control information τ_{r_1}(t) and τ_{l_1}(t).

In an embodiment, the processor 530 may change the delay value among the parameter values of the first control information τ_{r_1}(t) and τ_{l_1}(t) to a second delay value (e.g., 0.1) from the first delay value (e.g., 0.25). The processor 530 may further change at least one of the gain value or the sensitivity value in addition to changing the delay value from the first delay value to the second delay value.

The processor 530 may determine the second control information τ_{r_2}(t) and τ_{l_2}(t) based on the second delay value (e.g., 0.1), the first gain value, the first sensitivity value, the first raw angle information, and the second raw angle information and may control the driving module 520 based on the second control information to output a torque corresponding to the second control information τ_{r_2}(t) and τ_{l_2}(t).

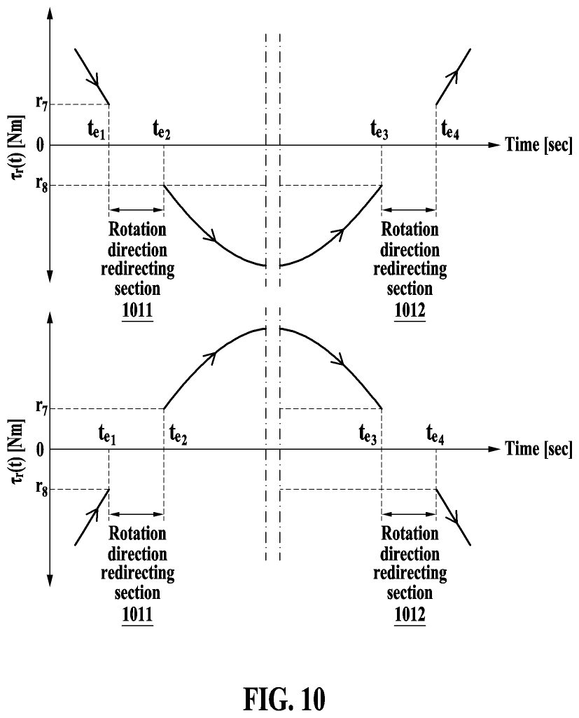

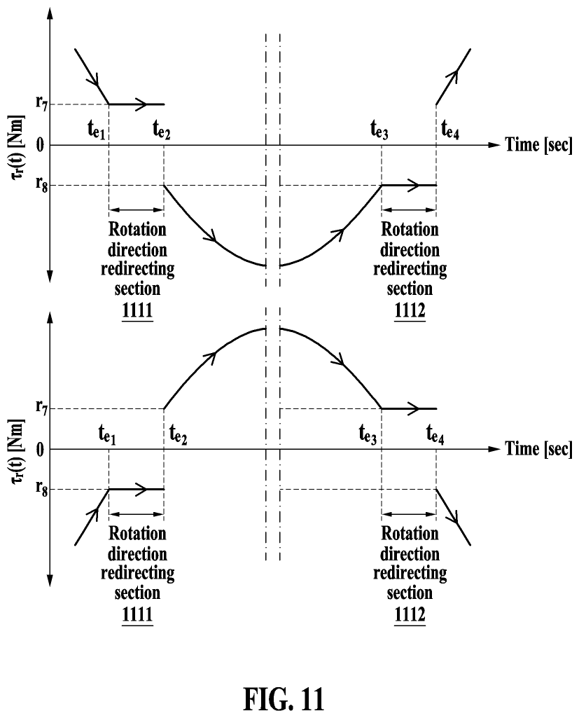

An embodiment in which the processor 530 changes the gain value from the first gain value to the second gain value (e.g., 0) is described below with reference to FIG. 10 and an embodiment in which the processor 530 changes the sensitivity value from the first sensitivity value to the second sensitivity value (e.g., 0) is described below with reference to FIG. 11.

In the rotation direction redirecting section 911, the processor 530 may maintain the changed parameter value.

At a time point tₑ₂, a torque value of τ_{r_2}(t) may reach the eighth reference value r₈ and a torque value of τ_{l_2}(t) may reach the seventh reference value r₇. The rotation direction redirecting section 911 may be terminated. In this case, the processor 530 may revert the changed parameter value to the parameter value before the change. For example, the processor 530 may change the delay value from the second delay value to the first delay value.

The processor 530 may determine the first control information τ_{r_1}(t) and τ_{l_1}(t) based on the first raw angle information, the second raw angle information, and the parameter values (e.g., the first delay value, the first gain value, and the first sensitivity value) and may control the driving module 520 to generate the torque corresponding to the first control information τ_{r_1}(t) and τ_{l_1}(t) based on the first control information τ_{r_1}(t) and τ_{l_1}(t).

At a time point tₑ₃, a torque value of τ_{r_1}(t) may reach the eighth reference value r₈ and a torque value of τ_{l_1}(t) may reach the seventh reference value r₇. In this case, the processor 530 may change at least one of the parameter values of the first control information τ_{r_1}(t) and τ_{l_1}(t). For example, the processor 530 may change the delay value from the first delay value to the second delay value. The processor 530 may further change at least one of the gain value or the sensitivity value in addition to changing the delay value from the first delay value to the second delay value.

The processor 530 may determine the second control information τ_{r_2}(t) and τ_{l_2}(t) based on the second delay value (e.g., 0.1), the first gain value, the first sensitivity value, the first raw angle information, and the second raw angle information and may control the driving module 520 based on the second control information to output a torque corresponding to the second control information τ_{r_2}(t) and τ_{l_2}(t).

In the rotation direction redirecting section 912, the processor 530 may maintain the changed parameter value.

At a time point tₑ₄, a torque value of τ_{r_2}(t) may reach the seventh reference value r₇ and a torque value of τ_{l_2}(t) may reach the eighth reference value r₈. In this case, the processor 530 may revert the changed parameter value to the parameter value before the change. For example, the processor 530 may change the delay value from the second delay value to the first delay value.

The processor 530 may determine the first control information τᵣ(t) and τₗ(t) based on the first raw angle information, the second raw angle information, and the parameter values (e.g., the first delay value, the first gain value, and the first sensitivity value) and may control the driving module 520 to generate the torque corresponding to the first control information τᵣ(t) and τₗ(t) based on the first control information τᵣ(t) and τₗ(t).

The embodiment when the gain value is changed is described with reference to FIG. 10.

In the example of FIG. 10, when the torque value of τ_{r_1}(t) reaches the seventh reference value r₇ and the torque value of τ_{l_1}(t) reaches the eighth reference value r₈ at the time point tₑ₁, the processor 530 may change the gain value among the parameter values of the first control information τ_{r_1}(t) and τ_{l_1}(t) from the first gain value to the second gain value (e.g., 0). The gain value may be changed from the first gain value to the second gain value (e.g., 0) and thereby, the torque may not be output.

In the example of FIG. 10, the processor 530 may determine whether redirection of the rotation direction of the hip joint is completed using the first raw angle information and/or the second raw angle information. At the time point tₑ₂, when the processor 530 determines that redirection of the rotation direction of the hip joint is completed, the processor 530 may revert the gain value from the second gain value to the first gain value. Since the second gain value is 0 in the rotation direction redirecting section 1011, the torque may not be output and when the processor 530 reverts the gain value from the second gain value to the first gain value, the processor 530 may determine the first control information τ_{r_1}(t) and τ_{l_1}(t) based on the first raw angle information, the second raw angle information, and the parameter values (e.g., the first delay value, the first gain value, and the first sensitivity value). The processor 530 may control the driving module 520 to generate the torque corresponding to the first control information τ_{r_1}(t) and τ_{l_1}(t), based on the first control information τ_{r_1}(t) and τ_{l_1}(t).

At a time point tₑ₃, a torque value of τ_{r_1}(t) may reach the eighth reference value r₈ and a torque value of τ_{l_1}(t) may reach the seventh reference value r₇. In this case, the processor 530 may change the gain value of the first control information τ_{r_1}(t) and τ_{l_1}(t) from the first gain value to the second gain value (e.g., 0). The torque may not be output.

The processor 530 may determine whether redirection of the rotation direction of the hip joint is completed using the first raw angle information and/or the second raw angle information. At the time point tₑ₄, when the processor 530 determines that redirection of the rotation direction of the hip joint is completed, the processor 530 may revert the gain value from the second gain value to the first gain value. Since the second gain value may be 0 in the rotation direction redirecting section 1012, the torque may not be output and when the processor 530 reverts the gain value from the second gain value to the first gain value, the processor 530 may determine the first control information τᵣ(t) and τₗ(t) based on the first raw angle information, the second raw angle information, and the parameter values (e.g., the first delay value, the first gain value, and the first sensitivity value). The processor 530 may control the driving module 520 to generate the torque corresponding to the first control information τᵣ(t) and τₗ(t), based on the first control information τᵣ(t) and τₗ(t).

The embodiment when the sensitivity value is changed is described with reference to FIG. 11.

In the example of FIG. 11, at the time point tₑ₁, the torque value of τ_{r_1}(t) may reach the seventh reference value r₇ and the torque value of τ_{l_1}(t) may reach the eighth reference value r₈. In this case, the processor 530 may change the sensitivity value among the parameter values of the first control information τ_{r_1}(t) and τ_{l_1}(t) from the first sensitivity value to the second sensitivity value (e.g., 0). Since the sensitivity value is changed from the first sensitivity value to the second sensitivity value (e.g., 0), the wearable device 500 may output a torque at a predetermined intensity. For example, when the first driving module 35 corresponding to the right hip joint generates a torque of 1 Nm and the second driving module 45 corresponding to the left hip joint generates a torque of −1 Nm, the sensitivity value may be changed from the first sensitivity value to the second sensitivity value. In this case, the processor 530 may control the first driving module 35 to generate the torque of 1 Nm and may control the second driving module 45 to generate the torque of −1 Nm. Depending on the embodiment, the processor 530 may further change at least one of the gain value or the delay value in addition to changing the sensitivity value from the first sensitivity value to the second sensitivity value.

In the example of FIG. 11, the processor 530 may determine whether redirection of the rotation direction of the hip joint is completed using the first raw angle information and/or the second raw angle information. At the time point tₑ₂, when the processor 530 determines that redirection of the rotation direction of the hip joint is completed, the processor 530 may revert the sensitivity value from the second sensitivity value to the first sensitivity value. The torque at the predetermined intensity may be output in a rotation direction redirecting section 1111 and when the processor 530 reverts the sensitivity value from the second sensitivity value to the first sensitivity value, the processor 530 may determine the first control information τ_{r_1}(t) and τ_{l_1}(t) based on the first raw angle information, the second raw angle information, and the parameter values (e.g., the first delay value, the first gain value, and the first sensitivity value). The processor 530 may control the driving module 520 to generate the torque corresponding to the first control information τ_{r_1}(t) and τ_{l_1}(t), based on the first control information τ_{r_1}(t) and τ_{l_1}(t).

At a time point tₑ₃, a torque value of τ_{r_1}(t) may reach the eighth reference value r₈ and a torque value of τ_{l_1}(t) may reach the seventh reference value r₇. In this case, the processor 530 may change the sensitivity value of the first control information τ_{r_1}(t) and τ_{l_1}(t) from the first sensitivity value to the second sensitivity value. The first driving module 35 and the second driving module 45 may output the torque at the predetermined intensity.

The processor 530 may determine whether redirection of the rotation direction of the hip joint is completed using the first raw angle information and/or the second raw angle information. At the time point tₑ₄, when the processor 530 determines that redirection of the rotation direction of the hip joint is completed, the processor 530 may revert the sensitivity value from the second sensitivity value to the first sensitivity value. The torque at the predetermined intensity may be output in a rotation direction redirecting section 1112 and when the processor 530 reverts the sensitivity value from the second sensitivity value to the first sensitivity value, the processor 530 may determine the first control information τᵣ(t) and τₗ(t) based on the first raw angle information, the second raw angle information, and the parameter values (e.g., the first delay value, the first gain value, and the first sensitivity value). The processor 530 may control the driving module 520 to generate the torque corresponding to the first control information τᵣ(t) and τₗ(t), based on the first control information τᵣ(t) and τₗ(t).

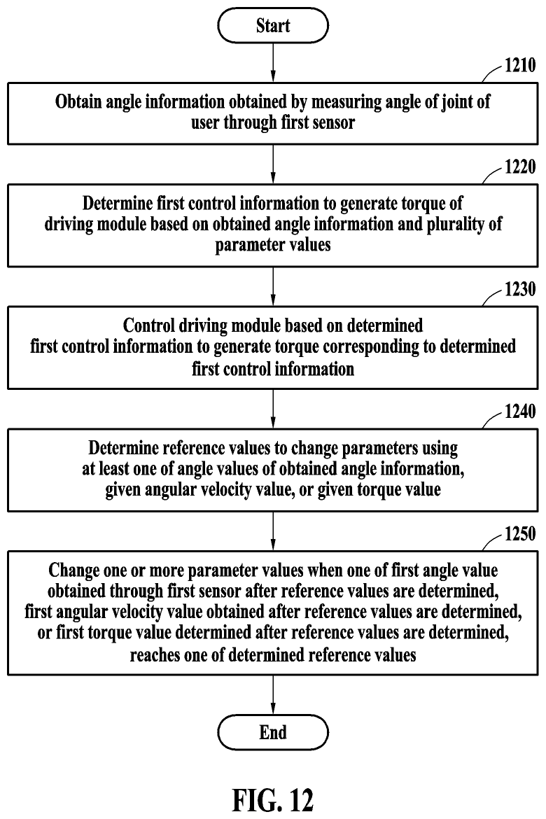

FIG. 12 is a flowchart illustrating a method of operating a wearable device, according to an embodiment.

In operation 1210, the wearable device 500 (e.g., the processor 530) may obtain angle information (e.g., the first raw angle information and the second raw angle information) obtained by measuring an angle of a joint of a user through the first sensor 510.

In operation 1220, the wearable device 500 (e.g., the processor 530) may determine first control information to generate a torque based on the obtained angle information and a plurality of parameter values (e.g., the first delay value, the first gain value, and the first sensitivity value).

In operation 1230, the wearable device 500 (e.g., the processor 530) may control the driving module 520 based on the first control information determined to generate the torque corresponding to the determined first control information.

In operation 1240, the wearable device 500 (e.g., the processor 530) may determine reference values to change parameters using at least one of angle values of the obtained angle information, a given angular velocity value, or a given torque value.

In an embodiment, the obtained angle information may include first angle information (e.g., q_r_raw(t) 610 of FIG. 6) obtained by measuring an angle of a first joint (e.g., the right hip joint) and second angle information (e.g., q_l_raw(t) 620 of FIG. 6) obtained by measuring an angle of a second joint (e.g., the left hip joint).

The processor 530 may detect first peak values (e.g., the positive peak values 610-1, 610-2, 610-3, 610-4, etc., of FIG. 6) and second peak values (e.g., the negative peak values 615-1, 615-2, 615-3, 615-4, etc.) from the angle values of the first angle information. The processor 530 may determine a first angle value (e.g., the first average angle value) at which a rotation direction of the first joint changes using the detected first peak values and may determine a second angle value (e.g., the second average angle value) at which the rotation direction of the first joint changes using the detected second peak values.

The processor 530 may detect third peak values (e.g., the positive peak values 620-1, 620-2, 620-3, 620-4, etc., of FIG. 6) and fourth peak values (e.g., the negative peak values 625-1, 625-2, 625-3, 625-4, etc., of FIG. 6) from the angle values of the second angle information. The processor 530 may determine a third angle value (e.g., the third average angle value) at which a rotation direction of the second joint changes using the detected third peak values and may determine a fourth angle value (e.g., the fourth average angle value) at which the rotation direction of the second joint changes using the detected fourth peak values.

The processor 530 may determine reference values (e.g., the first to fourth reference values) using the determined first to fourth angle values.

In an embodiment, the processor 530 may determine reference values (e.g., the fifth reference value and the sixth reference value) using a result obtained by adding a predetermined value ω₁ to a given angular velocity value (e.g., 0) and a result obtained by subtracting the predetermined value ω₁ from the given angular velocity value.

In an embodiment, the processor 530 may determine reference values (e.g., the seventh reference value and the eighth reference value) using a result obtained by adding a predetermined value τₓ to the given torque value (e.g., 0) and a result obtained by subtracting a predetermined value τ_{y} from the given torque value.

In operation 1250, when at least one of a first angle value obtained through the first sensor 510 after the reference values are determined, a first angular velocity value obtained after the reference values are determined, or a first torque value determined after the reference values are determined, reaches one of the determined reference values, the wearable device 500 (e.g., the processor 530) may change one or more parameter values.

For example, when the first angle value (e.g., the angle value of the left hip joint at the time point t_{b1} of FIG. 7) reaches the fourth reference value, the processor 530 may change one or more parameter values.

For example, when the first angular velocity value (e.g., the angular velocity value of the left hip joint at the time point t_{d1} of FIG. 8) reaches the sixth reference value, the processor 530 may change one or more parameter values.

For example, when the first torque value (e.g., the torque value at the time point tₑ₁ of FIG. 9) reaches the seventh reference value, the processor 530 may change one or more parameter values.

When one of a second angle value after the first angle value, a second angular velocity value after the first angular velocity value, or a second torque value after the first torque value reaches one of the reference values, the wearable device 500 (e.g., the processor 530) may revert the changed parameter value to the parameter value before the change.

For example, when the second angle value (e.g., the angle value of the right hip joint at the time point tₐ₂ of FIG. 7) reaches the first reference value, the processor 530 may revert the changed parameter value to the parameter value before the change.

For example, when the second angular velocity value (e.g., the angular velocity value of the right hip joint at the time point t_{c2} of FIG. 8) reaches the sixth reference value, the processor 530 may revert the changed parameter value to the parameter value before the change.

For example, when the second torque value (e.g., the torque value of τᵣ(t) at the time point tₑ₂ of FIG. 9) reaches the eighth reference value, the processor 530 may revert the changed parameter value to the parameter value before the change.

In an embodiment, when one of the first angle value, the first angular velocity value, or the first torque value reaches one of the reference values, the wearable device 500 (e.g., the processor 530) may determine the second control information by changing a delay value among the parameter values from the first delay value to the second delay value and may control the driving module 520 based on the determined second control information. When one of the second angle value after the first angle value, the second angular velocity value after the first angular velocity value, or the second torque value after the first torque value reaches one of the reference values, the wearable device 500 (e.g., the processor 530) may revert the delay value from the second delay value to the first delay value.

In an embodiment, when one of the first angle value, the first angular velocity value, or the first torque value reaches one of the reference values, the wearable device 500 (e.g., the processor 530) may change the gain value among the parameter values from the first gain value to the second gain value to generate a torque at intensity less than the torque based on the first control information or to cause the motor not to generate the torque.

In an embodiment, when one of the first angle value, the first angular velocity value, or the first torque value reaches one of the reference values, the wearable device 500 (e.g., the processor 530) may change the sensitivity value among the parameter values from the first sensitivity value to the second sensitivity value to generate the torque at the predetermined intensity.

The embodiments described with reference to FIGS. 1 to 11 may apply to the operating method of FIG. 12.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or pseudo equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

Therefore, other implementations, other embodiments, and/or equivalents of the claims are within the scope of the following claims.

1. A wearable device comprising:
a first sensor configured to measure an angle of a joint of a user;
a driving module, comprising a motor and/or circuitry, configured to apply an external force to the user at least by generating a torque via the motor; and
a processor, comprising processing circuitry, configured to:
receive angle information obtained by measuring the angle from the first sensor,
determine first control information to generate the torque based on the received angle information and a plurality of parameter values,
control the driving module based on the determined first control information to generate a torque corresponding to the determined first control information,
determine reference values to change a parameter using at least one of angle values of the received angle information, a given angular velocity value, or a given torque value, and
when at least one of a first angle value received from the first sensor after the reference values are determined, a first angular velocity value obtained after the reference values are determined, or a first torque value determined after the reference values are determined, reaches one of the determined reference values, change one or more parameter values.

2. The wearable device of claim 1,
wherein the received angle information comprises:
first angle information obtained at least by measuring an angle of a first joint and second angle information obtained at least by measuring an angle of a second joint, and
the processor is further configured to:
detect first peak values and second peak values from angle values of the first angle information, determine a first angle value at which a rotation direction of the first joint changes using the detected first peak values, determine a second angle value at which the rotation direction of the first joint changes using the detected second peak values, detect third peak values and fourth peak values from angle values of the second angle information, determine a third angle value at which a rotation direction of the second joint changes using the detected third peak values, determine a fourth angle value at which the rotation direction of the second joint changes using the detected fourth peak values, and determine the reference values using the determined first to fourth angle values.

3. The wearable device of claim 1,
wherein the processor is further configured to:
determine the reference values using a result obtained at least by adding a predetermined value to the given angular velocity value and a result obtained at least by subtracting the predetermined value from the given angular velocity value, and/or determine the reference values using a result obtained at least by adding a predetermined value to the given torque value and a result obtained at least by subtracting the predetermined value from the given torque value.

4. The wearable device of claim 1,
wherein the processor is further configured to:
when at least one of a second angle value after the first angle value, a second angular velocity value after the first angular velocity value, or a second torque value after the first torque value reaches one of the reference values, revert the changed parameter value to a parameter value before the change.

5. The wearable device of claim 1,
wherein the parameter values comprise a gain value related to an intensity of the torque, a delay value related to an output timing of the torque, and a sensitivity value indicating a coefficient of a filter that filters the received angle information.

6. The wearable device of claim 5,
wherein the processor is further configured to:
when at least one of the first angle value, the first angular velocity value, or the first torque value reaches one of the reference values, determine second control information at least by changing the delay value from a first delay value to a second delay value and control the driving module based on the determined second control information.

7. The wearable device of claim 6,
wherein the processor is further configured to:
when at least one of the second angle value after the first angle value, the second angular velocity value after the first angular velocity value, or the second torque value after the first torque value reaches one of the reference values, change the delay value from the second delay value to the first delay value.

8. The wearable device of claim 5,
wherein the processor is further configured to:
when at least one of the first angle value, the first angular velocity value, or the first torque value reaches one of the reference values, change the gain value from a first gain value to a second gain value to generate a torque at an intensity that is less than the torque or cause the motor not to generate the torque; or
when at least one of the first angle value, the first angular velocity value, or the first torque value reaches one of the reference values, change the sensitivity value from a first sensitivity value to a second sensitivity value to generate a torque at a predetermined intensity.

9. A method of operating a wearable device, the method comprising:
obtaining angle information obtained at least by measuring an angle of a joint of a user via a first sensor;
determining first control information to generate torque of a driving module based on the obtained angle information and a plurality of parameter values;
controlling the driving module based on the determined first control information to generate a torque based on the determined first control information;
determining reference values to change a parameter using at least one of angle values of the obtained angle information, a given angular velocity value, or a given torque value; and
when at least one of a first angle value obtained via the first sensor after the reference values are determined, a first angular velocity value obtained after the reference values are determined, or a first torque value determined after the reference values are determined, reaches at least one of the reference values, changing one or more parameter values.

10. The method of claim 9,
wherein the obtained angle information comprises:
first angle information obtained at least by measuring an angle of a first joint and second angle information obtained at least by measuring an angle of a second joint,
the determining of the reference values comprises:
detecting first peak values and second peak values from angle values of the first angle information;
determining a first angle value at which a rotation direction of the first joint changes using the detected first peak values;
determining a second angle value at which the rotation direction of the first joint changes using the detected second peak values;
detecting third peak values and fourth peak values from angle values of the second angle information;
determining a third angle value at which a rotation direction of the second joint changes using the detected third peak values;
determining a fourth angle value at which the rotation direction of the second joint changes using the detected fourth peak values; and
determining the reference values using the determined first to fourth angle values.

11. The method of claim 9,
wherein the determining of the reference values comprises:
determining the reference values using at least a result obtained by adding a predetermined value to the given angular velocity value and a result obtained at least by subtracting the predetermined value from the given angular velocity value; and/or
determining the reference values using a result obtained at least by adding a predetermined value to the given torque value and a result obtained at least by subtracting the predetermined value from the given torque value.

12. The method of claim 9, further comprising:
when one of a second angle value after the first angle value, a second angular velocity value after the first angular velocity value, or a second torque value after the first torque value reaches one of the reference values, reverting the changed parameter value to a parameter value before the change.

13. The method of claim 9,
wherein the parameter values comprise a gain value related to an intensity of the torque, a delay value related to an output timing of the torque, and a sensitivity value indicating a coefficient of a filter that filters the obtained angle information.

14. The method of claim 13, further comprising:
when at least one of the first angle value, the first angular velocity value, or the first torque value reaches one of the reference values, determining second control information at least by changing the delay value from a first delay value to a second delay value and controlling the driving module based on the determined second control information;
when at least one of the first angle value, the first angular velocity value, or the first torque value reaches one of the reference values, changing the gain value from a first gain value to a second gain value to generate a torque at an intensity that is less than the torque or cause the driving module not to generate the torque; and/or
when at least one of the first angle value, the first angular velocity value, or the first torque value reaches one of the reference values, changing the sensitivity value from a first sensitivity value to a second sensitivity value to generate a torque at a predetermined intensity.

15. The method of claim 14, further comprising:
when one of the second angle value after the first angle value, the second angular velocity value after the first angular velocity value, or the second torque value after the first torque value reaches one of the reference values, changing the delay value from the second delay value to the first delay value.
